(19) United States
(12) Patent Application Publication
(10) Pub. No.: US 2026/0058897 A1
(43) Pub. Date: Feb. 26, 2026

(54) COMPUTER-READABLE RECORDING MEDIUM, INFORMATION PROCESSING APPARATUS, AND DETERMINATION METHOD

(71) Applicant: Fujitsu Limited, Kawasaki-shi (JP)

(72) Inventor: Atsushi KITADA, Kawasaki (JP)

(73) Assignee: Fujitsu Limited, Kawasaki-shi (JP)

(21) Appl. No.: 19/271,101

(22) Filed: Jul. 16, 2025

(30) Foreign Application Priority Data
Aug. 20, 2024 (JP) 2024-139338

(51) Int. Cl. H04L 45/02; H04L 43/50

(52) U.S. Cl. CPC H04L 45/02; H04L 43/50

(57) ABSTRACT

A non-transitory computer-readable recording medium have stored therein a determination program that causes a computer to execute a process including in a system in which a switch is directly connected to a device that does not support a link layer discovery protocol (LLDP), acquiring, for each switch of a plurality of switches on a connection path of the device, correspondence relation between a port number on a switch side, a MAC address of the device, and link layer discovery protocol reception availability, and determining a switch corresponding to an entry indicating that link layer discovery protocol reception is unavailable among entries in the correspondence relation as an adjacent switch of a device indicating a MAC address of the entry.

### CROSS-REFERENCE TO RELATED APPLICATION(S)

This application is based upon and claims the benefit of priority of the prior Japanese Patent Application No. 2024-139338, filed on August 20, 2024, the entire contents of which are incorporated herein by reference.

### FIELD

The embodiment(s) discussed herein is (are) related to a determination program and the like.

### BACKGROUND

In recent years, the Link Layer Discovery Protocol (LLDP) has been known as a protocol for collecting information about adjacent nodes of Layer 2. LLDP is standardized as IEEE802.3AB. If a network device (L2 switch) supports the link layer discovery protocol (LLDP), a server that manages the network can use LLDP to exchange information between adjacent Layer 2 network devices, thereby grasping the topology of the Layer 2 network. LLDP works according to the Ethernet communication standard. For example, when a network is distributed using Ethernet multicast, each network device (L2 switch) on the network can recognize adjacent nodes from received packets.

In addition, although LLDP is not used, there is a known technology for grasping the topology of a Layer 2 network (see, for example, Japanese Laid-open Patent Publication No. 2023-128353).

### SUMMARY

According to an aspect of the embodiments, a non-transitory computer-readable recording medium have stored therein a determination program that causes a computer to execute a process including: in a system in which a switch is directly connected to a device that does not support a link layer discovery protocol (LLDP), acquiring, for each switch of a plurality of switches on a connection path of the device, correspondence relation between a port number on a switch side, a MAC address of the device, and link layer discovery protocol reception availability; and determining a switch corresponding to an entry indicating that link layer discovery protocol reception is unavailable among entries in the correspondence relation as an adjacent switch of a device indicating a MAC address of the entry.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a flow of a determination process according to an embodiment;

FIG. 2 is a diagram illustrating an example of a functional configuration of a determination apparatus according to an embodiment;

FIG. 3 is a diagram illustrating an example of a host information table according to an embodiment;

FIG. 4 is a diagram illustrating an example of a configuration of a switch information table according to an embodiment;

FIG. 5 is a diagram illustrating an example of a determination process according to an embodiment;

FIG. 6 is a diagram illustrating an example of a determination process according to an embodiment;

FIG. 7 is a diagram illustrating an example of a determination process according to an embodiment;

FIG. 8 is a diagram illustrating an example of a flowchart of a determination process according to an embodiment;

FIG. 9 is a diagram illustrating an example of a computer that executes a determination program;

FIG. 10 is a reference diagram for explaining a frame format of LLDP;

FIG. 11 is a reference diagram for explaining grasping of an L2 (Ethernet) topology from LLDP;

FIG. 12 is a diagram for explaining a problem when an LLDP-unsupported device is connected; and

FIG. 13 is a diagram for explaining a problem when an LLDP-unsupported device is connected.

### DESCRIPTION OF EMBODIMENTS

However, if a device does not support LLDP, in some cases, it is not possible to grasp which L2 switch the Layer 2 interface of the device is connected to. For example, if there is only one L2 switch on a network, the MAC address of the device is known from the MAC address learning table in the L2 switch, and it is possible to grasp which L2 switch the Layer 2 interface of the device is connected to. However, if there are multi-stage L2 switches on a network, the MAC address is learned by all the L2 switches through which a packet has passed, and it is not possible to grasp which L2 switch the device is connected to.

Preferred embodiments of the present invention will be explained with reference to accompanying drawings. Note that the present invention is not limited to the embodiment.

First, a protocol used to collect information about adjacent nodes of Layer 2 (L2) is described. As an example of such a protocol, LLDP is known. LLDP is standardized as IEEE802.3AB. Therefore, most network devices from network vendors, such as switches and routers, support LLDP. In addition, LLDP works according to the Ethernet communication standard. For example, when packets are distributed on a network using Ethernet multicast, each network device on the network can recognize adjacent nodes from received packets. That is, if all the network devices on the network support LLDP, an information processing apparatus that manages the network can use LLDP to collect information about exchange of information between adjacent Layer 2 network devices to grasp the topology of the Layer 2 network. Hereinafter, a Layer 2 may be referred to as L2.

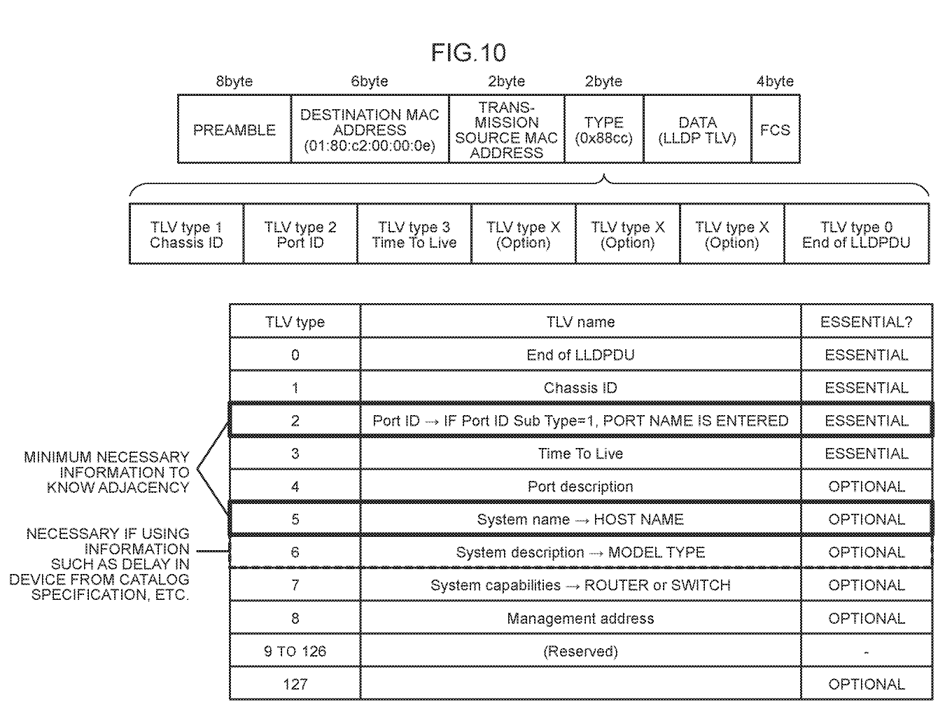

FIG. 10 is a reference diagram for explaining a frame format of LLDP. As illustrated in FIG. 10, a frame is allocated areas for destination MAC address, transmission source MAC address, data, and the like. Among these, the area for data is a frame format for LLDP. The frame format for LLDP is represented in a TLV format. For example, an area for PortID is allocated at a position where TLV type is "2". For PortID, if SubType is "1", a port name is set. In addition, an area for System name is allocated at a position where TLV type is "5". System name is set as a host name. PortID and System name are minimum requested information to know adjacent nodes. Hereinafter, the frame may be referred to as a packet.

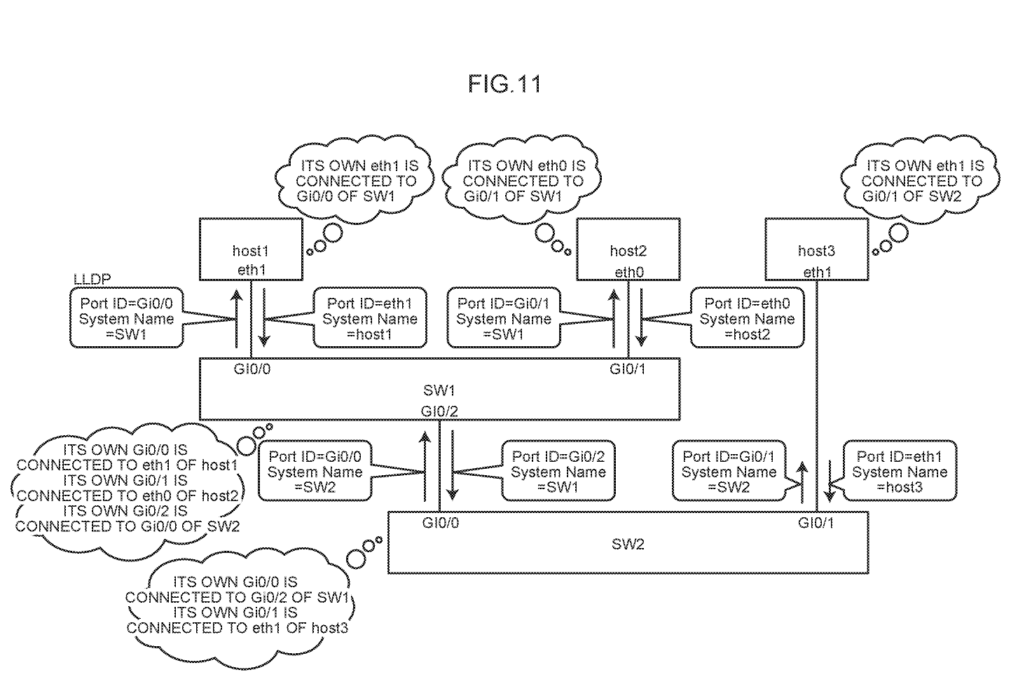

FIG. 11 is a reference diagram for explaining the grasping of an L2 (Ethernet) topology from LLDP. As illustrated in FIG. 11, when a packet is transmitted from a host 1, an SW 1 that has received the packet acquires information about the host 1 from the received packet. That is, the information about the host 1 is "eth1" as PortID and "host1" as System name. In addition, when a packet is transmitted from a host 2, the SW 1 that has received the packet acquires information about the host 2 from the received packet. That is, the information about the host 2 is "eth0" as PortID and "host2" as System name. In addition, when a packet is transmitted from an SW 2, the SW 1 that has received the packet acquires information about the SW 2 from the received packet. That is, the information about the SW 2 is "Gi0/0" as PortID and "SW2" as System name. Accordingly, it can be seen that, regarding the SW 1, its own "Gi0/0" is connected to "eth1" of "host1", its own "GI0/1" is connected to "eth0" of "host2", and its own "GI0/2" is connected to "Gi0/0" of "SW2". That is, the SW 1 recognizes "host1", "host2", and "SW2" as its adjacent nodes from the received packets.

Similarly, when a packet is transmitted from the SW 1, the host 1 that has received the packet acquires information about the SW 1 from the received packet. That is, the information about the SW 1 is "Gi0/0" as PortID and "SW1" as System name. Accordingly, it can be seen that, regarding the host 1, its own "eth1" is connected to "Gi0/0" of "SW1". That is, the host 1 recognizes "SW1" as its adjacent node from the received packet.

Similarly, the host 2 recognizes "SW1" as its adjacent node from a received packet. A host 3 recognizes "SW2" as its adjacent node from a received packet. The SW 2 recognizes "SW1" and "host3" as its adjacent nodes from a received packet.

The information processing apparatus can grasp the L2 topology by collecting information about the adjacent nodes from each node connected to the Layer 2 network.

Here, LLDP is an IEEE standard protocol, and works with most switches, on-board Linux (registered trademark)/Windows (registered trademark) and expansion Network Interface Card (NIC). Therefore, the L2 topology can be grasped from LLDP. In recent years, however, there have been advances in accelerator technology called an xPU, which offloads the processing that is performed by a CPU (Central Processing Unit). Although the number of xPUs with Ethernet interfaces is increasing, not all xPUs support LLDP. For xPUs that do not support LLDP, the L2 topology is not grasped. Note that examples of xPUs include a graphics processing unit (GPU), a data processing unit (DPU), and the like.

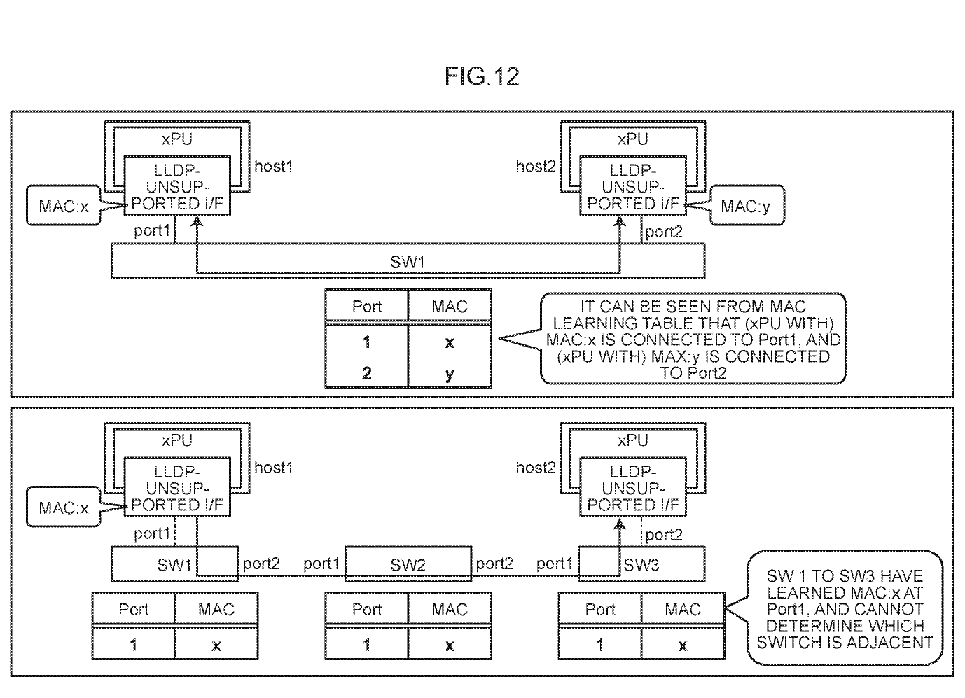

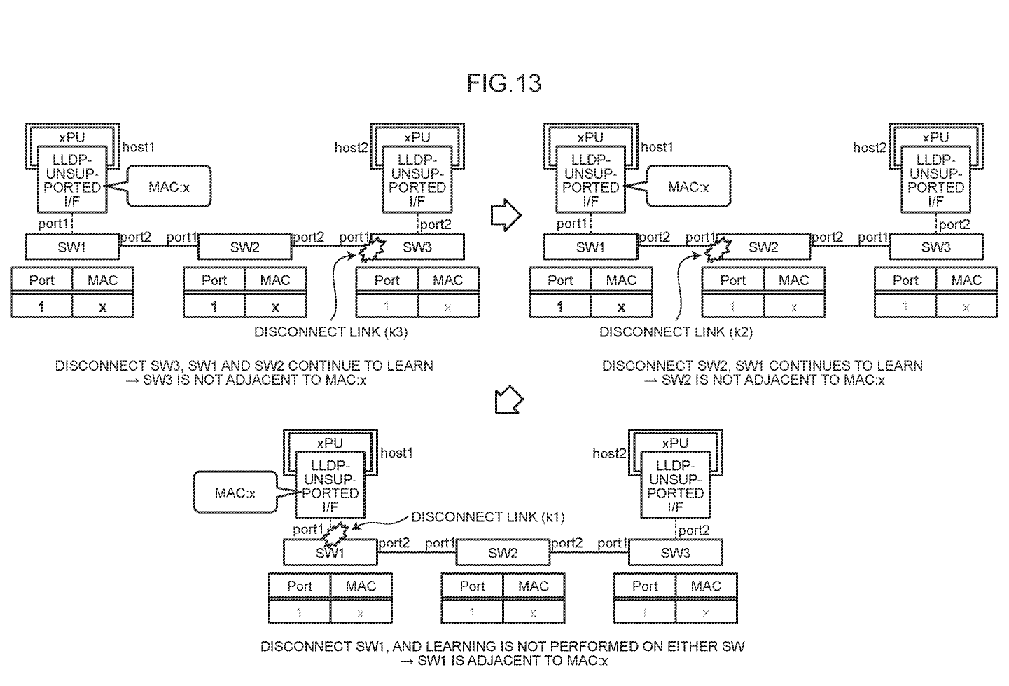

FIGS. 12 and 13 are diagrams for explaining a problem when an LLDP-unsupported device is connected. In FIG. 12, the xPU mounted on each of the host 1 and the host 2 does not support LLDP.

The upper part of FIG. 12 illustrates a case of a simple topology with only one switch. In such a case, since the MAC addresses of the xPUs are known from the MAC address learning table, it is possible to determine which port the xPUs are connected to. That is, when a packet is transmitted from the host 1, the SW 1 learns a MAC address "x" of the transmission source of the packet. When a packet is transmitted from the host 2, the SW 1 learns a MAC address "y" of the transmission source of the packet. Then, the SW 1 grasps, from the MAC address learning table, that the xPU with the MAC address "x" is connected to Port1 and the xPU with the MAC address "y" is connected to Port2.

The lower part of FIG. 12 illustrates a case of a topology with multi-stage switches. In such a case, since the transmission source MAC address is learned by all the switches through which the packet passes, it is not possible to determine which switch the MAC address of the transmission source is adjacent to. That is, when a packet is transmitted from the host 1, each of the SW 1, the SW 2, and the SW 3 learns the MAC address "x" of the transmission source of the packet. Then, each of the SWs 1 to 3 has learned the MAC address "x" at Port1, and it is not possible to determine which switch the xPU with the MAC address "x" is adjacent to.

Here, there is a method to determine the adjacent node by sequentially disconnecting the links of the ports that are learning the MAC address and checking how far they are learning. In FIG. 13, similarly to FIG. 12, the xPU mounted on each of the host 1 and the host 2 does not support LLDP. In addition, similarly to the lower part of FIG. 12, FIG. 13 illustrates a case of multi-stage switches.

As illustrated in FIG. 13, when a packet is transmitted from the host 1, each of the SW 1, the SW 2, and the SW 3 learns the MAC address "x" of the transmission source of the packet.

Under such a situation, as indicated by the reference sign k3, when the link of Port1 of the SW 3 that is learning is disconnected and then a packet is transmitted again from the host 1, the SW 1 and the SW 2 continue to learn. Therefore, the SW 3 is not adjacent to the xPU with MAC address "x".

Next, as indicated by the reference sign k2, when the link of Port1 of the SW 2 during learning is disconnected and then a packet is transmitted again from the host 1, the SW 1 still continues to learn. Therefore, the SW 2 is not adjacent to the xPU with MAC address "x".

Next, as indicated by the reference sing k1, when the link of Port1 of the SW 1 during learning is disconnected and then a packet is transmitted again from the host 1, learning is not performed on either SW. Therefore, it can be seen that the SW 1 is adjacent to the xPU with the MAC address "x".

However, such a method affects the system, such as disconnecting communication of other traffic. Therefore, the following embodiment describes a determination apparatus that determines which L2 switch an L2 interface of a device that does not support LLDP is connected to without affecting the system.

### Image of determination process

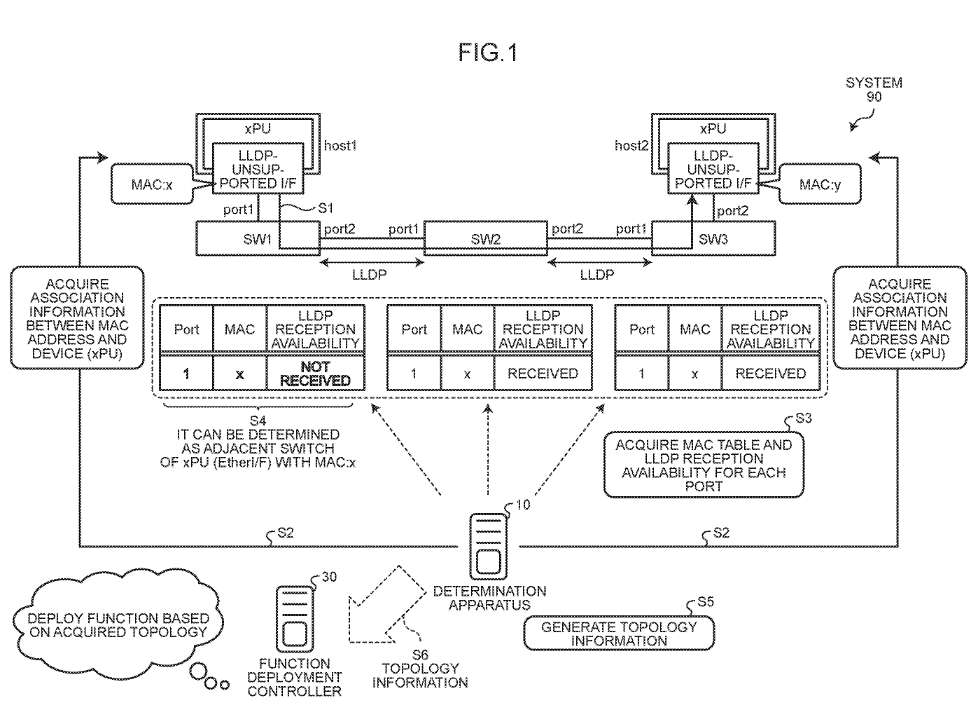

FIG. 1 is a diagram illustrating a flow of a determination process according to the embodiment. As illustrated in FIG. 1, a system 90 includes, for example, a determination apparatus 10, hosts 1 and 2, a plurality of SWs 1 to 3, and a function deployment controller 30. The hosts 1 and 2 are examples of a device including an LLDP-unsupported xPU. The SWs 1 to 3 are L2 switches that support LLDP and are connected in multiple stages. Note that the SWs 1 to 3 may be routers instead of switches. In FIG. 1, the number of SWs is three, but is not limited thereto.

The determination apparatus 10 determines which L2 switch an L2 interface of a device that does not support LLDP is connected to.

For example, the determination apparatus 10 causes the host 1 to transmit a test packet (S1). This is to cause the SWs 1 to 3 on the connection path of the xPU mounted on the host 1 to learn the MAC address of the xPU. As an example, the host 1 transmits a test packet with the transmission source MAC address as the MAC address "x" of the xPU itself. Note that since the xPU mounted on the host 1 does not support LLDP, LLDP is not transmitted. Then, each of the SWs 1 to 3 learns the MAC address "x" from the received packet and identifies LLDP reception availability. As a result, each of the SWs 1 to 3 stores a MAC table in which the MAC address "x" is associated with the port number "1" on the SW side, and associates the LLDP reception availability for each port number. Here, the SW 1 stores the MAC table in which Port "1" is associated with the MAC address "x". In addition, "Not received" is associated with Port "1" as the LLDP reception availability.

On the other hand, the SW 2 stores the MAC table in which Port "1" is associated with the MAC address "x". In addition, "Received" is associated with Port "1" as the LLDP reception availability. This is because the SW 2 receives LLDP from the SW 1 that supports LLDP. The SW 3 stores the MAC table in which Port "1" is associated with the MAC address "x". In addition, "Received" is associated with Port "1" as the LLDP reception availability. This is because the SW 3 receives LLDP from the SW 2 that supports LLDP.

That is, the SWs can grasp the adjacency between the SWs from LLDP described in FIG. 11. In addition, depending on the LLDP reception availability, it can be seen that from which port of which SW an unknown connection destination starts. Here, it can be seen that the connection destination from Port "1" of the SW 1 is unknown.

Then, the determination apparatus 10 acquires association information between the MAC address and the host name from the host 1 whose adjacent SW is unknown (S2). Here, the MAC address "x" is associated with the host name "host1" in the association information.

Then, the determination apparatus 10 acquires, for each of the SWs 1 to 3, correspondence relation in which the MAC table is associated with the LLDP reception availability for each port number (S3). That is, the determination apparatus 10 acquires, for each of the SWs 1 to 3, the correspondence relation between the port number on the switch side, the MAC address of the xPU, and the LLDP reception availability.

Then, based on the acquired correspondence relation for each of the SWs 1 to 3, the determination apparatus 10 determines that the SW 1 is the adjacent switch of the xPU with the MAC address "x" (S4). That is, the determination apparatus 10 determines the adjacent switch of the LLDP-unsupported xPU based on the MAC table and whether LLDP is running. In other words, the determination apparatus 10 determines the MAC address "x" learned from a port (Port "1") whose connection destination is unknown (LLDP not received) as the MAC address adjacent to the port.

Similarly, the determination apparatus 10 causes the host 2 to transmit a test packet. Accordingly, each of the SWs 1 to 3 learns the MAC address "y" from the received packet and identifies LLDP reception availability. It can be seen that the connection destination is unknown from Port "2" of the SW 3 depending on the LLDP reception availability. Then, the determination apparatus 10 acquires association information between the MAC address and the host name from the host 2 whose adjacent SW is unknown. Then, the determination apparatus 10 acquires, for each of the SWs 1 to 3, the MAC table and the LLDP reception availability for each port number. Then, based on the acquired correspondence relation for each of the SWs 1 to 3, the determination apparatus 10 determines that the SW 3 is the adjacent switch of the xPU with the MAC address "y". In other words, the determination apparatus 10 determines the MAC address "y" learned from a port (Port "2") whose connection destination is unknown (LLDP not received) as the MAC address adjacent to the port.

Then, the determination apparatus 10 generates L2 topology information indicating which device (xPU) is connected to the port of the SW by using the result determined in S4 and the association information acquired in S2 (S5). In this case, the L2 topology information in which "host1" is connected to the port of the SW 1 and "host2" is connected to the port of the SW 3 is generated.

Thereafter, the determination apparatus 10 transmits the generated L2 topology information to the function deployment controller 30 (S6).

Here, the function deployment controller 30 deploys a function based on the acquired L2 topology information, for example. That is, in a form of providing a service called a microservice, service functions that constitutes an application are deployed on a plurality of servers (hosts). Then, these service functions can be networked together to constitute one application. In such a case, when connecting the service functions, for example, there may be a case in which it is desired to select the path with the least number of SW hops to pass through in order to minimize the delay. In order to achieve this case, the function deployment controller 30 needs to know the topology of how the hosts on which the service functions are to be deployed and the SWs are connected and how the SWs are connected. In other words, the function deployment controller 30 needs to know what the hosts on which the service functions are to be deployed and the adjacent nodes of the SWs are. Therefore, the function deployment controller 30 can achieve delay minimization by deploying the service functions based on the L2 topology information generated by the determination apparatus 10.

### Functional configuration of determination apparatus

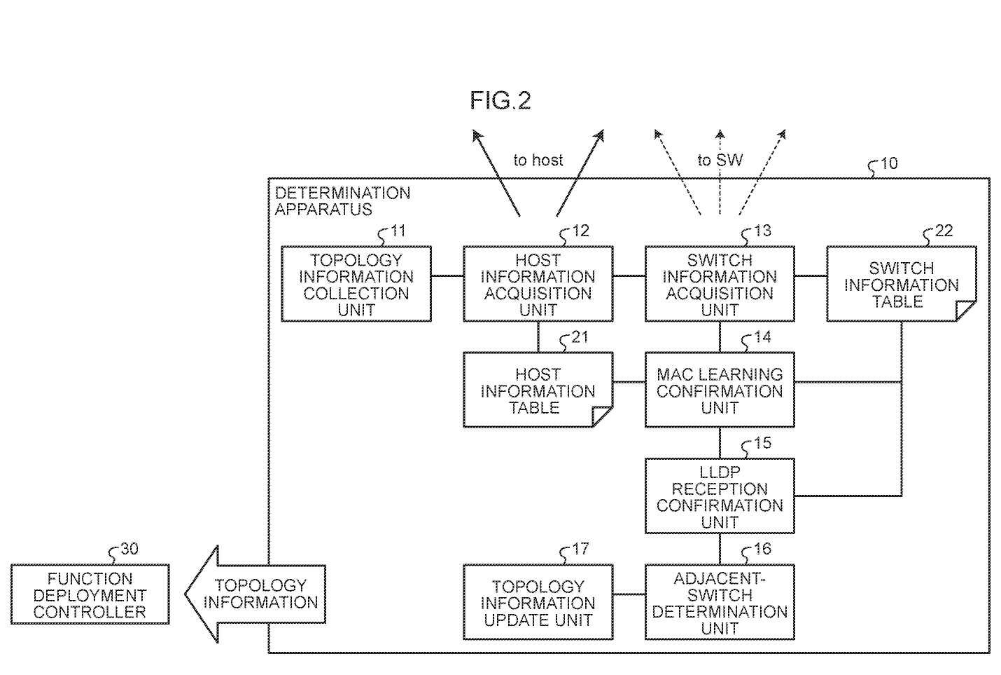

FIG. 2 is a diagram illustrating an example of a functional configuration of a determination apparatus according to an embodiment. As illustrated in FIG. 2, the determination apparatus 10 includes a topology information collection unit 11, a host information acquisition unit 12, a switch information acquisition unit 13, a MAC learning confirmation unit 14, an LLDP reception confirmation unit 15, an adjacent-switch determination unit 16, and a topology information update unit 17. In addition, the determination apparatus 10 stores a host information table 21 and a switch information table 22 in a storage unit (not illustrated).

The topology information collection unit 11 collects topology information about the system 90.

For example, the topology information collection unit 11 causes a device to transmit a test packet and causes switches on the connection path to learn the MAC address. In addition, the topology information collection unit 11 causes the device to identify the LLDP reception availability. The test packet referred to herein may be, for example, ping, and is only requested to be set with a transmission source MAC address.

Each switch on the connection path identifies LLDP reception availability as "available" if LLDP is received, and identifies LLDP reception availability as "unavailable" if LLDP is not received. As a result, each switch holds switch information indicating correspondence relation between a port number on the switch side, a MAC address of the device, and LLDP reception availability. The device referred to herein is, for example, the host 1 or 2 illustrated in FIG. 1. The switches referred to herein are, for example, the SWs 1 to 3 illustrated in FIG. 1.

Then, based on the port ID on the LLDP transmission source side and the host name received by each switch, the topology information collection unit 11 collects topology information between the switches and between the switch and the device. If the device does not support LLDP, the switches connected to the device do not identify the port ID and the host name on the LLDP transmission source side and thus do not recognize the device. The unrecognizable device is a device whose adjacent switch is unknown.

The host information acquisition unit 12 acquires host information about the device whose adjacent switch is unknown. For example, the host information acquisition unit 12 extracts the device whose adjacent switch is unknown from the topology information collected by the topology information collection unit 11. Then, the host information acquisition unit 12 acquires host information in which the MAC address of the device is associated with the host name from the extracted device. Then, the host information acquisition unit 12 stores the acquired host information in the host information table 21.

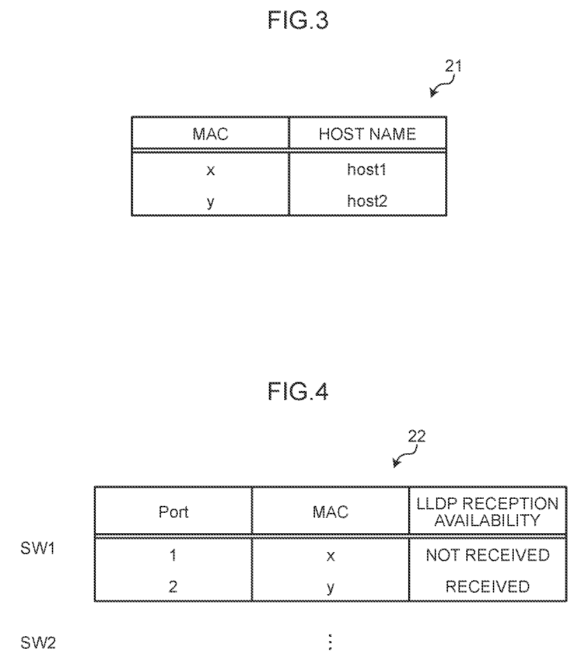

Here, an example of a configuration of the host information table 21 is described with reference to FIG. 3. FIG. 3 is a diagram illustrating an example of a configuration of a host information table according to an embodiment. The host information table 21 stores host information in which a MAC address is associated with a host name. The MAC address is the MAC address of a device. The host name is a name uniquely representing the device. As an example, when MAC is "x", "host1" is set as the host name. When MAC is "y", "host2" is set as the host name.

Returning to FIG. 2, the switch information acquisition unit 13 acquires switch information about each switch. For example, the switch information acquisition unit 13 acquires switch information from each switch on the system 90. Then, the switch information acquisition unit 13 stores the switch information acquired from each switch in the switch information table 22. That is, the switch information acquisition unit 13 stores, for each switch, the correspondence relation between the port number on the switch side, the MAC address of the device, and the LLDP reception availability.

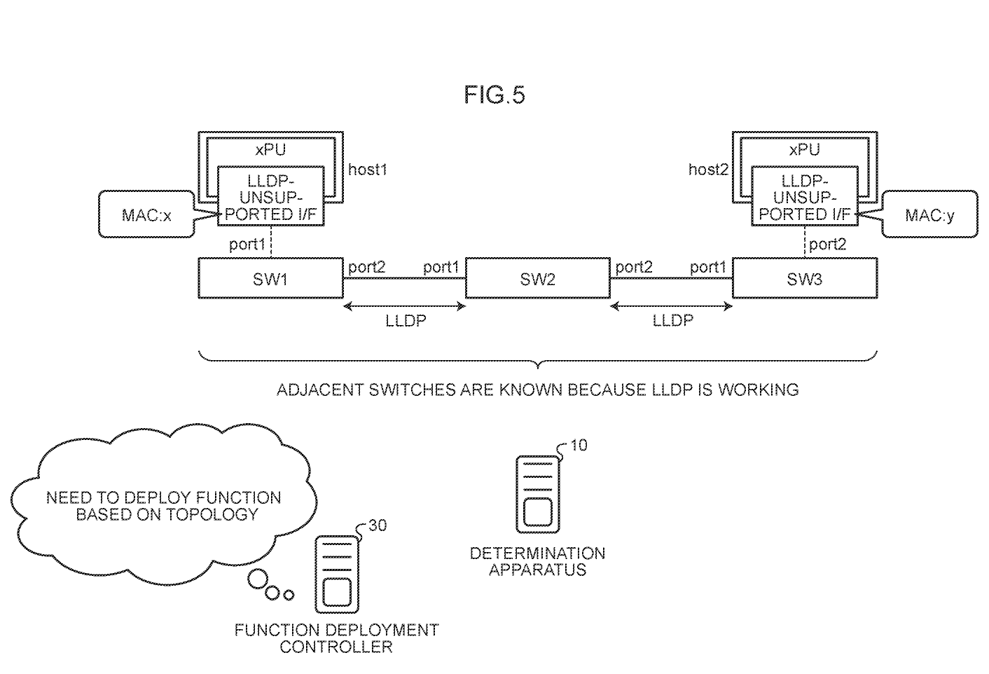

Here, an example of a configuration of the switch information table 22 is described with reference to FIG. 4. FIG. 4 is a diagram illustrating an example of a configuration of a switch information table according to an embodiment. As illustrated in FIG. 4, the switch information table 22 stores, for each switch, the correspondence relation in which Port, MAC, and LLDP reception availability are associated with each other. Port is a port number on the switch side when the device is learned. MAC is the MAC address of the learned device. LLDP reception availability indicates whether the device can receive LLDP most recently transmitted. When LLDP is received, "Received" indicating that LLDP reception is "available" is set in LLDP reception availability, for example. When LLDP is not received, "Not received" indicating that LLDP reception is "unavailable" is set in LLDP reception availability, for example.

As an example, when the name of the switch is "SW1", "1" is associated as Port, "x" is associated as MAC, "Not received" is associated as LLDP reception availability, "2" is associated as Port, "y" is associated as MAC, and "Received" is associated as LLDP reception availability.

Returning to FIG. 2, the MAC learning confirmation unit 14 confirms whether the MAC address of the device whose adjacent switch is unknown has been learned. For example, the MAC learning confirmation unit 14 extracts the MAC address of the device whose adjacent switch is unknown from the host information table 21. Then, the MAC learning confirmation unit 14 confirms, for each switch, whether the extracted MAC address has been learned using the switch information table 22. As an example, the MAC learning confirmation unit 14 sequentially extracts the MAC address associated with the host name from the host information table 21. Then, the MAC learning confirmation unit 14 confirms, for each switch, whether the extracted MAC address has been learned (set) from the switch information table 22 corresponding to the switch.

The LLDP reception confirmation unit 15 confirms whether LLDP has been received at the port at which learning has been performed. For example, the LLDP reception confirmation unit 15 confirms, for each switch, whether LLDP has been received at the port at which the MAC address has been learned using the switch information table 22. As an example, when learning (setting) of the target MAC address is confirmed by the MAC learning confirmation unit 14 for a specific switch, the LLDP reception confirmation unit 15 confirms the LLDP reception availability from the corresponding switch information table 22.

The adjacent-switch determination unit 16 determines an adjacent switch of the device whose adjacent switch is unknown. For example, when the LLDP reception confirmation unit 15 has not confirmed the reception of LLDP at the port at which the MAC address has been learned for the specific switch, the adjacent-switch determination unit 16 determines that the specific switch is the adjacent switch of the device indicating the MAC address. That is, the adjacent-switch determination unit 16 determines the switch corresponding to an entry indicating that LLDP reception is unavailable among the entries in the switch information table 22 as the adjacent switch of the device indicating the MAC address of the entry.

The topology information update unit 17 updates topology information. For example, the topology information update unit 17 reflects (updates) topology information between the switch and the device that have been determined to be adjacent to each other by the adjacent-switch determination unit 16 in the topology information collected by the topology information collection unit 11. Thereafter, when updating the topology information about all the devices whose adjacent switches are unknown, the topology information update unit 17 transmits the updated topology information to the function deployment controller 30.

### Example of determination process

Here, an example of a determination process performed by the determination apparatus 10 is described with reference to FIGS. 5 to 7. FIGS. 5 to 7 are diagrams illustrating an example of a determination process according to an embodiment.

As illustrated in FIG. 5, for example, it is assumed that the function deployment controller 30 needs to know the L2 topology between the host 1 and the host 2 including LLDP-unsupported xPUs. That is, since the function deployment controller 30 needs to know the number of switch hops in order to deploy functions based on the L2 topology. Here, since LLDP is working in the SW 1 to the SW 3, the adjacent switches are known. However, since the host 1 and the host 2 do not support LLDP, it is unclear to which switch they are connected. That is, the connection relation among the host 1, the SW 1 to the SW 3, and the host 2 illustrated in FIG. 5 is topology information indicating the currently known L2 topology.

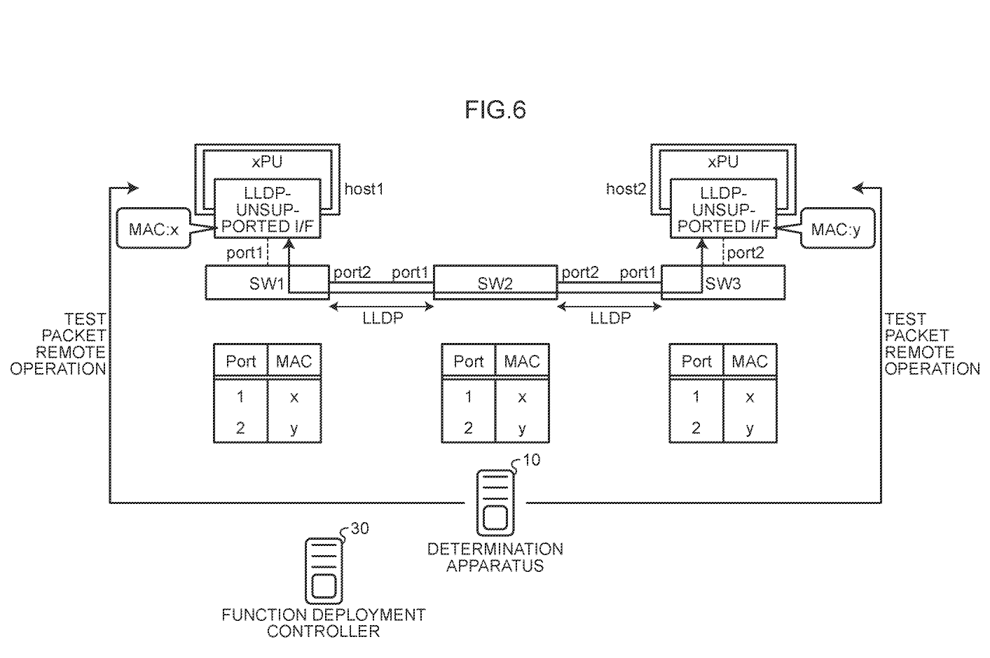

Under such a situation, as illustrated in FIG. 6, in the determination apparatus 10, the topology information collection unit 11 transmits, from the host 1, a test packet with the MAC address ("x") of the xPU mounted on the host 1 as the transmission source address, and causes the SWs 1 to 3 to learn the MAC address. In addition, in the determination apparatus 10, the topology information collection unit 11 transmits, from the host 2, a test packet with the MAC address ("y") of the xPU mounted on the host 2 as the transmission source address, and causes the SWs 1 to 3 to learn the MAC address. Then, the SW 1 to the SW 3 hold MAC information indicating the port number on the switch side and the MAC address "x" of the xPU mounted on the host 1. In addition, the SW 1 to the SW 3 hold MAC information indicating the port number on the switch side and the MAC address "y" of the xPU mounted on the host 2.

Here, in the MAC information of the SW 1, when Port is "1", "x" is associated as the MAC address, and when Port is "2", "y" is associated as the MAC address. The MAC information of the SW 2 and the SW 3 is also associated similarly to the SW 1. Note that, in FIG. 6, the port numbers on the switch side of all the SWs 1 to 3 are coincidentally the same, but the port numbers are not limited thereto, and may be numbers of ports that have received the test packet.

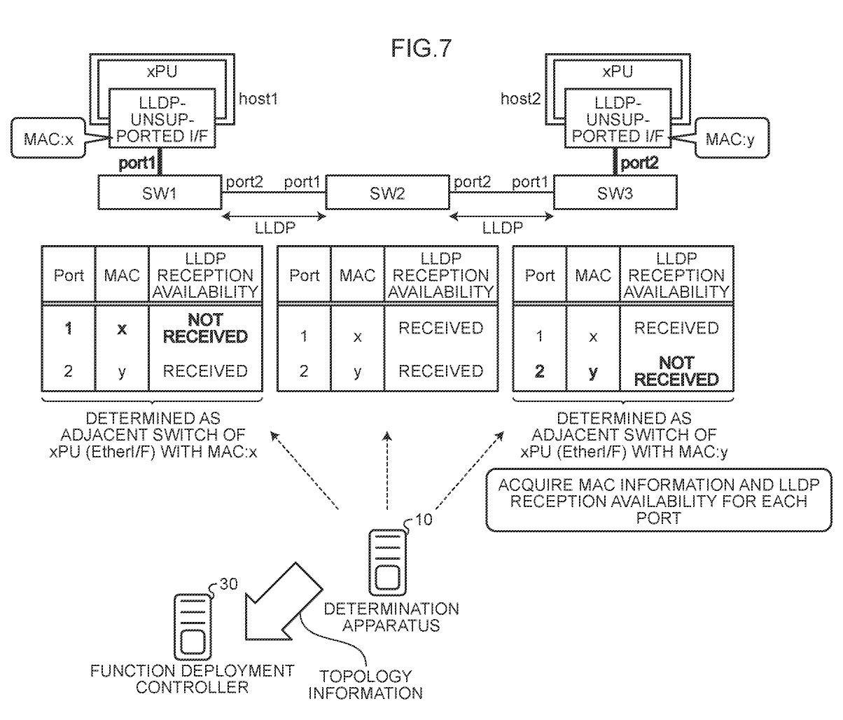

As illustrated in FIG. 7, in the determination apparatus 10, when transmitting the test packet from the host 1, the topology information collection unit 11 causes the SW 1 to 3 to identify LLDP reception availability. As a result, each of the SWs 1 to 3 associates the MAC information with the LLDP reception availability for each port number on the switch side. That is, each of the SWs 1 to 3 holds switch information indicating the correspondence relation between the port number on the switch side, the MAC address of the xPU mounted on the host, and the LLDP reception availability.

Here, regarding the SW 1, when the port number (Port) on the switch side is "1", "Not received" is associated as the LLDP reception availability, and when the port number (Port) on the switch side is "2", "Received" is associated as the LLDP reception availability. Regarding the SW 2, when the port number (Port) on the switch side is "1", "Received" is associated as the LLDP reception availability, and when the port number (Port) on the switch side is "2", "Received" is associated as the LLDP reception availability. Regarding the SW 3, when the port number (Port) on the switch side is "1", "Received" is associated as the LLDP reception availability, and when the port number (Port) on the switch side is "2", "Not received" is associated as the LLDP reception availability.

Then, in the determination apparatus 10, the switch information acquisition unit 13 stores, for each of the SWs 1 to 3, switch information indicating the correspondence relation between the port number on the switch side, the MAC address of the SW, and the LLDP reception availability in the switch information table 22. In addition, the host information acquisition unit 12 acquires host information about the hosts 1 and 2 from the hosts 1 and 2 including the xPUs whose adjacent switches are unknown, and stores the host information in the host information table 21.

Then, the determination apparatus 10 learns the MAC address and determines a switch in which LLDP reception availability is "Not received" at the port at which learning has been performed. For example, regarding the host 1 including the xPU whose adjacent switch is unknown, the MAC learning confirmation unit 14 extracts the MAC address of the xPU mounted on the host 1 from the host information table 21. Here, the extracted MAC address is "x". Then, the MAC learning confirmation unit 14 confirms, for each SW, whether the extracted MAC address has been learned using the switch information table 22. Here, it is confirmed that the MAC address "x" has been learned at Port "1" of the SW 1 to the SW 3. Then, the LLDP reception confirmation unit 15 confirms, for each SW, whether LLDP has been received at the port at which the MAC address "x" has been learned using the switch information table 22. Here, regarding the SW 1, at Port "1" at which the MAC address "x" has been learned, the LLDP reception availability is determined as "Not received". Therefore, the SW 1 is determined to be the adjacent switch of the xPU with the MAC address "x".

Next, regarding the host 2 whose adjacent SW is unknown, the MAC learning confirmation unit 14 extracts the MAC address of the xPU mounted on the host 2 from the host information table 21. Here, the extracted MAC address is "y". Then, the MAC learning confirmation unit 14 confirms, for each SW, whether the extracted MAC address has been learned using the switch information table 22. Here, it is confirmed that the MAC address "y" has been learned at Port "2" of the SW 1 to the SW 3. Then, the LLDP reception confirmation unit 15 confirms, for each SW, whether LLDP has been received at the port at which the MAC address "y" has been learned using the switch information table 22. Here, regarding the SW 3, at Port "2" at which the MAC address "y" has been learned, the LLDP reception availability is determined as "Not received". Therefore, the SW 3 is determined to be the adjacent switch of the xPU with the MAC address "y".

Then, the topology information update unit 17 reflects (updates) the topology information between the SW and the host that has been determined to be adjacent to each other in the topology information illustrated in FIG. 5. Thereafter, the topology information update unit 17 transmits the updated topology information to the function deployment controller 30. As a result, the function deployment controller 30 deploys functions based on the transmitted topology information.

Accordingly, the determination apparatus 10 can efficiently grasp which L2 switch a Layer 2 interface of a device that does not support LLDP is connected to.

### Flowchart of determination process

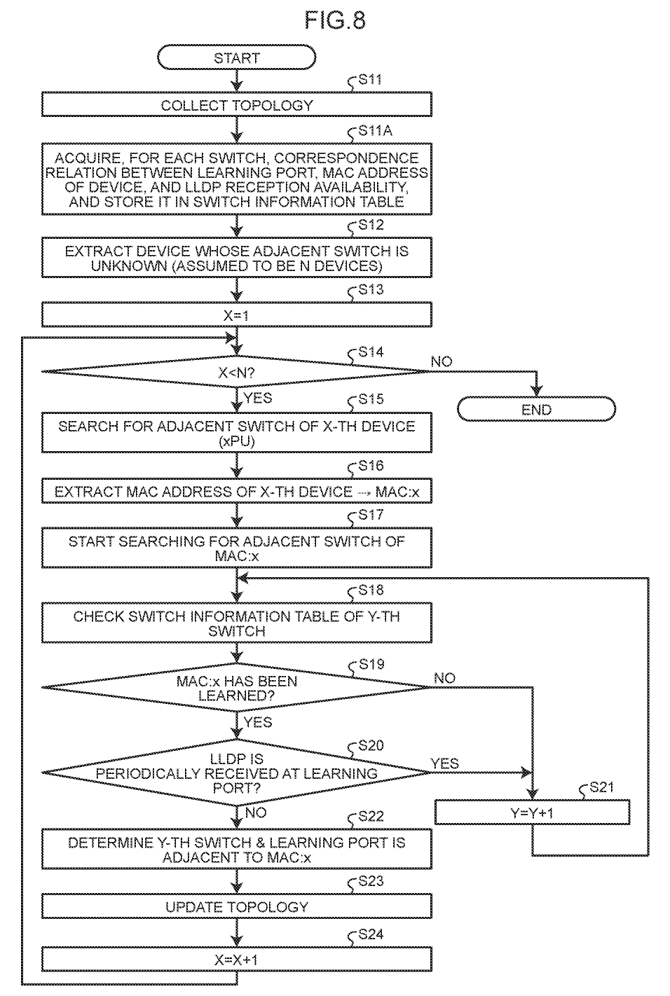

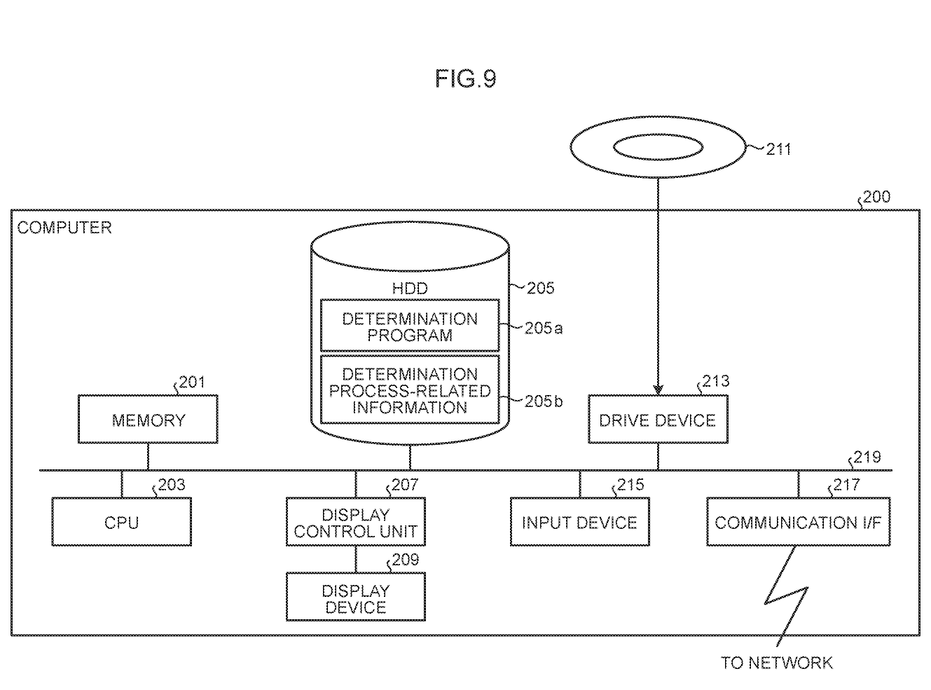

Here, a flowchart of a determination process performed by the determination apparatus 10 is described with reference to FIG. 8. FIG. 8 is a diagram illustrating an example of a flowchart of a determination process according to an embodiment.

As illustrated in FIG. 8, the determination apparatus 10 collects topology information about devices and switches included in the system 90 (Step S11). For example, the determination apparatus 10 causes a device included in the system 90 to transmit a test packet. Then, based on the test packet received by each switch, the determination apparatus 10 collects topology information between the switches and between the switch and the device.

Then, the determination apparatus 10 acquires, for each switch, the correspondence relation between a learning port, a MAC address of the device, and LLDP reception availability, and stores the correspondence relation in the switch information table 22 (Step S11A).

Then, the determination apparatus 10 extracts a device whose adjacent switch is unknown from the collected topology information (Step S12). Here, it is assumed that there are N (N is an integer of 1 or more) target devices. The determination apparatus 10 sets "1" in an index X representing the processing order of the target devices (Step S13).

The determination apparatus 10 determines whether the index X is less than the maximum number N of target devices (Step S14). When determining that X is less than N (Step S14; Yes), the determination apparatus 10 searches for the adjacent switch of the X-th device (xPU) as in the following Steps S16 to S22 (Step S15).

First, the determination apparatus 10 extracts the MAC address of the X-th device (Step S16). Here, it is assumed that the extracted MAC address is "x". For example, the determination apparatus 10 acquires, from the X-th device, host information in which the MAC address of the device is associated with the host name. Then, the determination apparatus 10 extracts the MAC address from the host information.

Subsequently, the determination apparatus 10 starts searching for the adjacent switch of the MAC address "x" (Step S17). Hereinafter, an index Y represents the processing order of the target switches. The determination apparatus 10 checks the switch information table 22 of the Y-th switch (Step S18). As a result of the checking, the determination apparatus 10 determines whether the MAC address "x" has been learned (Step S19). When determining that the MAC address "x" has not been learned (Step S19; No), the determination apparatus 10 proceeds to Step S21 to process the next switch.

On the other hand, when determining that the MAC address "x" has been learned (Step S19; Yes), the determination apparatus 10 determines whether LLDP is periodically received at the learning port at which the MAC address "x" has been learned (Step S20). When determining that LLDP is periodically received at the learning port (Step S20; Yes), the determination apparatus 10 determines that the Y-th switch is not adjacent to the LLDP-unsupported device, and proceeds to Step S21 to process the next switch. In Step S21, the determination apparatus 10 adds 1 to the index Y and proceeds to Step S18.

On the other hand, when determining that LLDP is not periodically received at the learning port (Step S20; No), the determination apparatus 10 determines the Y-th switch as the adjacent switch of the xPU with the MAC address "x" learned at the learning port (Step S22). Then, the determination apparatus 10 updates the topology information (Step S23). Then, the determination apparatus 10 adds 1 to the index X (Step S24). Then, the determination apparatus 10 proceeds to Step S14.

In Step S14, when determining that X is not less than N (Step S14; No), the determination apparatus 10 terminates the determination process since all the devices have been processed.

### Effects of embodiment

According to the above embodiment, in the system 90, switches are directly connected to a host that does not support LLDP. The determination apparatus 10 acquires, for each of a plurality of switches on a connection path of the host, correspondence relation between a port number on the switch side, a MAC address of the host, and LLDP reception availability. The determination apparatus 10 determines a switch corresponding to an entry indicating that LLDP reception is unavailable among the entries in the correspondence relation as the adjacent switch of the host indicating the MAC address of the entry. Accordingly, by using the correspondence relation, the determination apparatus 10 can efficiently grasp which switch a device (host) that does not support LLDP is connected to without affecting the system 90.

In addition, according to the above embodiment, the determination apparatus 10 causes the host to transmit a test packet to acquire the correspondence relation. Accordingly, the determination apparatus 10 can cause each of the plurality of switches on the connection path of the host to generate the correspondence relation.

In addition, according to the above embodiment, the determination apparatus 10 collects a topology indicating connection relation of the system when causing the host to transmit the test packet. Then, the determination apparatus 10 reflects connection relation between the adjacent switch determined in the determination process and the device on the collected topology. Accordingly, even if there is a device (host) that does not support LLDP in the system, the determination apparatus 10 can grasp which switch the host that does not support LLDP is connected to and accurately generate the topology of the system.

### Others

Note that each constituent element of the determination apparatus 10 illustrated in the drawings is not necessarily physically configured as illustrated in the drawings. That is, a specific aspect of distribution and integration of the determination apparatus 10 is not limited to the illustrated ones, and all or a part thereof can be functionally or physically distributed and integrated in an arbitrary unit according to various loads, usage conditions, and the like. Furthermore, a storage unit (not illustrated) that stores various tables and the like may be connected via a network as an external device of the determination apparatus 10.

In the embodiment, the function deployment controller 30 is physically distinguished from the determination apparatus 10, but is not limited thereto. The determination apparatus 10 may include the function of function deployment controller 30.

In addition, the various processes described in the above embodiment can be implemented by executing a program prepared in advance on a computer such as a personal computer or a workstation. Therefore, in the following, an example of a computer that executes a determination program that implements functions similar to those of the determination apparatus 10 illustrated in FIG. 2 is described. Here, a determination program that implements functions similar to those of the determination apparatus 10 is described as an example. FIG. 9 is a diagram illustrating an example of a computer that executes the determination program.

As illustrated in FIG. 9, a computer 200 includes a central processing unit (CPU) 203 that executes various types arithmetic processes, an input device 215 that receives an input of data from a user, and a display device 209. In addition, the computer 200 includes a drive device 213 that reads a program and the like from a storage medium, and a communication interface (I/F) 217 that exchanges data with another computer via a network. In addition, the computer 200 includes a memory 201 that temporarily stores various types of information, and a hard disk drive (HDD) 205. The memory 201, the CPU 203, the HDD 205, the display control unit 207, the display device 209, the drive device 213, the input device 215, and the communication I/F 217 are connected by a bus 219.

The drive device 213 is, for example, a device for a removable disk 211. The HDD 205 stores a determination program 205a and determination process-related information 205b. The communication I/F 217 manages an interface between the network and the inside of the device, and controls input and output of data from another computer. As the communication I/F 217, for example, a modem, a LAN adapter, or the like can be used.

The display device 209 is a display device that displays data such as a document, an image, and functional information, including a cursor, an icon, or a tool box. As the display device 209, for example, a liquid crystal display, an organic electroluminescence (EL) display, or the like can be used.

The CPU 203 reads the determination program 205a, loads the program in the memory 201, and executes the program as a process. Such a process corresponds to each functional unit of the determination apparatus 10. The determination process-related information 205b includes, for example, various tables such as the host information table 21 and the switch information table 22. Then, for example, the removable disk 211 stores each piece of information such as the determination program 205a.

Note that the determination program 205a does not necessarily have to be pre-stored on the HDD 205. For example, the program may be stored in a "portable physical medium" such as a flexible disk (FD), a CD-ROM, a DVD disk, a magneto-optical disk, or an IC card to be inserted into the computer 200. Then, the computer 200 may read and execute the determination program 205a from these.

The process performed by the determination apparatus 10 described in the above embodiment can be applied to a case in which it is desired to grasp the L2 topology in a system in which a device (for example, an xPU) that does not support LLDP is mixed.

According to one aspect, it is possible to efficiently grasp which L2 switch a Layer 2 interface of a device that does not support LLDP is connected to.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a determination program that causes a computer to execute a process comprising:
in a system in which a switch is directly connected to a device that does not support a link layer discovery protocol (LLDP), acquiring, for each switch of a plurality of switches on a connection path of the device, correspondence relation between a port number on a switch side, a MAC address of the device, and link layer discovery protocol reception availability; and
determining a switch corresponding to an entry indicating that link layer discovery protocol reception is unavailable among entries in the correspondence relation as an adjacent switch of a device indicating a MAC address of the entry.

2. The non-transitory computer-readable recording medium according to claim 1, wherein the acquiring the correspondence relation includes causing the device to transmit a test packet to acquire the correspondence relation.

3. The non-transitory computer-readable recording medium according to claim 2, the process further including:
collecting a topology indicating connection relation of the system when causing the device to transmit the test packet, and reflecting connection relation between the adjacent switch determined in the determining and the device on the collected topology.

4. An information processing apparatus that supports a system in which a switch is directly connected to a device that does not support a link layer discovery protocol (LLDP), the information processing apparatus comprising:
a memory; and
a processor configured to:
acquire, for each switch of a plurality of switches on a connection path of the device, correspondence relation between a port number on a switch side, a MAC address of the device, and link layer discovery protocol reception availability; and
determine a switch corresponding to an entry indicating that link layer discovery protocol reception is unavailable among entries in the correspondence relation as an adjacent switch of a device indicating a MAC address of the entry.

5. A determination method comprising:
in a system in which a switch is directly connected to a device that does not support a link layer discovery protocol (LLDP), acquiring, for each switch of a plurality of switches on a connection path of the device, correspondence relation between a port number on a switch side, a MAC address of the device, and link layer discovery protocol reception availability; and
determining a switch corresponding to an entry indicating that link layer discovery protocol reception is unavailable among entries in the correspondence relation as an adjacent switch of a device indicating a MAC address of the entry, by a processor.
